(19) United States
(12) Patent Application Publication
(10) Pub. No.: US 2025/0251500 A1
(43) Pub. Date: Aug. 7, 2025

(54) Sensor Calibration Systems And Associated Methods

(71) Applicant: Darsense, Inc., Austin, TX (US)

(72) Inventor: Kunle T. OLUTOMILAYO, Leander, TX (US)

(21) Appl. No.: 19/016,202

(22) Filed: Jan. 10, 2025

Related U.S. Application Data
(60) Provisional application No. 63/550,482, filed on Feb. 6, 2024.

(51) Int. Cl. G01S 7/497; G01S 17/931; G06T 7/80

(52) U.S. Cl. CPC G01S 7/497; G06T 7/85; G01S 17/931; G06T 2207/30252

(57) ABSTRACT

The present disclosure relates to sensor calibration systems for sensor-equipped units, such as vehicles. The system includes a multiaxis rotating platform or an assembly of platforms capable of rotation and tilt in three-dimensional space around yaw, pitch, and roll axes. The system also features a plurality of fiducial targets positioned on and around a rotating platform, with some fiducials rotating with the platform, along with a scene tracking system to monitor and track the fiducial targets and the sensor-equipped unit. In one embodiment, the sensor-equipped unit rotates around a set of fiducial targets, while in another, a set of fiducial targets rotate around the sensor-equipped unit. A controller, coupled to the sensors, platforms, and scene tracking system, receives and processes data from these components. It analyzes the data and determines at least one calibration parameter from the processed data to calibrate one or more sensors.

### CROSS-REFERENCE TO RELATED APPLICATION

This application claims the benefit of U.S. Provisional Application No. 63/550,482 filed on Feb. 6, 2024. The entire disclosure of the above application is incorporated herein by reference.

### FIELD

The present invention relates generally to sensor calibration and, more specifically, to a sensor calibration system that calibrates multiple sensors of sensor-equipped units simultaneously.

### BACKGROUND

This section provides background information related to the present disclosure which is not necessarily prior art.

Sensor-equipped units, including but not limited to vehicles such as autonomous cars, drones, and robots, rely on a diverse suite of sensors, including cameras, lidar, radar, inertial measurement unit (IMUs), and ultrasonic sensors, to perceive and navigate their surroundings. Each sensor has unique characteristics and requires precise calibration to ensure accurate and reliable data fusion. Calibration involves determining intrinsic parameters (internal to the sensor) and extrinsic parameters (the sensor's position and orientation). Calibration parameters may also include a scale factor to normalize sensor outputs, time synchronization offsets among multiple sensors, and intrinsic corrections tailored to each sensor type. Accurate multisensor calibration is essential for precise data fusion, enabling reliable perception and navigation of the vehicle's surroundings.

Conventional calibration methods often calibrate sensors individually, leading to a time-consuming and costly process. This not only increases production time but also incurs significant costs. Further, this approach also introduces potential errors due to manual alignment and data collection for each sensor.

Some existing methods attempt to calibrate multiple sensors simultaneously but are constrained by limitations. These methods typically involve rotating a vehicle on a turntable restricted to two-dimensional rotation (yaw only), which fails to capture data variations along the pitch and roll axes, thereby compromising sensor calibration accuracy. For sensors such as IMUs, which measure motion in three-dimensional space, two-dimensional rotations are insufficient to fully calibrate key parameters, including sensitivity alignment, scale factor calibration, and drift compensation. Additionally, the reliance on vehicle-only rotation in existing methods introduces inflexibility, as certain vehicles such as large or heavy-duty vehicles with limited maneuverability may be difficult to rotate effectively.

Accordingly, there is a need for a solution to the aforementioned problems. For example, there exists a need for a sensor calibration system and an associated method that is capable of simultaneously calibrating multiple sensors, enabling three-dimensional rotation, and offering the flexibility of a rotation mechanism that can rotate the vehicle or operate without vehicle rotation.

### SUMMARY

This section provides a general summary of the disclosure, and is not a comprehensive disclosure of its full scope or all of its features.

According to an implementation of the present disclosure, a sensor calibration system for sensor-equipped units, such as vehicles, is provided. The system includes a multiaxis rotating platform configured to rotate in three-dimensional space around the yaw, pitch, and roll axes. The platform is sized to receive a vehicle, which is placed on the platform to calibrate the sensors thereof. Fiducial targets are positioned both on and around the platform, with some fiducials rotating alongside the platform, and a scene tracking system tracks and monitors the fiducial targets and the vehicle in real-time, capturing positional shifts during the rotation of the platform. A controller is coupled to at least one of the one or more sensors, the platform, and the scene tracking system. The controller is configured to receive calibration data from the one or more sensors, the platform, and the scene tracking system, estimate at least one calibration parameter from the calibration data, and calibrate the one or more sensors based on the estimated at least one calibration parameter.

In an aspect, the at least one calibration parameter corresponding to the one or more sensors may comprise rotation and orientation parameters such as sensor orientation (R), translation and position parameters such as sensor position (t), a scale factor to normalize sensor outputs, time synchronization offset among multiple sensors, and intrinsic calibration parameters specific to the sensors.

In an aspect, to estimate the sensor orientation (R), the controller may be configured to compute a plurality of instantaneous rotations (Rᵢ) for a plurality set of detections from the one or more sensors and the scene tracking system, decompose each of the computed plurality of instantaneous rotations (Rᵢ) into yaw, pitch, and roll components, determine an average yaw component, an average pitch component, and an average roll component based on the decomposed components, and estimate the sensor orientation based on the determined average yaw component, average pitch component, and average roll component.

In an aspect, to estimate the sensor orientation (R), the controller may be configured to compute a centroid for each of a plurality set of detections from the one or more sensors and the scene tracking system, determine a plurality set of non-zero detections based on the computed centroid for each of the plurality set of detections, and estimate the sensor orientation based on the determined plurality set of non-zero detections.

In an aspect, to estimate the sensor position, the controller may be configured to determine a rotation matrix Q_{(θ}_{ᵢ}₎ for a set of yaw, pitch, and roll angles represented in vector θᵢ, and a displacement vector (d) based on the calibration data received from the plurality of fiducial targets and estimate the sensor position based on the determined rotation matrix Q_{(θ}_{ᵢ}₎ and the displacement vector (d).

In an aspect, the controller is configured to transform a point feature from a fiducial coordinate system (FCS) to a tracker coordinate system (TCS).

In an aspect, to calibrate the one or more sensors based on the estimated at least one calibration parameter, the controller is configured to transform a point feature from a sensor coordinate system (SCS) to a unified coordinate system (UCS) based on the estimated at least one calibration parameter.

In an aspect, the sensor calibration system may comprise a plurality of fiducial targets positioned on and around a multiaxis rotating platform and in proximity to the vehicle for calibration.

In an aspect, one or more sensors may be configured to detect both fiducial targets and non-fiducial targets features, such as edges, textures, or patterns, that are present in the calibration environment as the multiaxis rotary platform moves.

In an aspect, the scene tracking system may be configured to monitor, and track both fiducial targets and non-fiducial targets features, such as edges, textures, or patterns, that are present in the calibration environment as the multiaxis rotary platform moves.

In an aspect, the multiaxis rotating platform may incorporate multiple components to enable three-dimensional rotation around the yaw, pitch, and roll axes. These components may include distinct rotational mechanisms such as stacked axes for independent control of yaw, pitch, and roll, gimbal systems for coordinated or sequential motion, a combination of rotary stages and actuators for precise motion control, spherical joint mechanisms for tilt operations, rotary components for yaw, pitch, and roll, or direct-drive motors for independent and precise rotation along each axis.

According to another implementation of the present disclosure, a sensor calibration system for sensor-equipped units, such as vehicles, is provided. The system includes an assembly of platforms which comprises a multiaxis rotary platform and a second platform. The multiaxis rotary platform enables three-dimensional rotation of the platform around the yaw, pitch, and roll axes. The second platform can either remain stationary or configured to tilt in three-dimensional space around the yaw, pitch, and roll axes. A vehicle is placed on the second platform for calibration. Fiducial targets are positioned both on and around the rotary platform, with some fiducials rotating alongside the rotary platform, and a scene tracking system tracks and monitors the fiducial targets and the vehicle in real-time, capturing positional shifts during the rotation of the rotary platform. A controller is coupled to at least one of the one or more sensors, the assembly of platforms, and the scene tracking system. The controller is configured to receive calibration data from the one or more sensors, the assembly of platforms, and the scene tracking system, estimate at least one calibration parameter from the calibration data, and calibrate the one or more sensors based on the estimated at least one calibration parameter.

In an aspect, the at least one calibration parameter corresponding to the one or more sensors may comprise rotation and orientation parameters such as sensor orientation (R), translation and position parameters such as sensor position (t), a scale factor to normalize sensor outputs, time synchronization offset among multiple sensors, and intrinsic calibration parameters specific to the sensors.

In an aspect, to estimate the sensor orientation (R), the controller may be configured to compute a plurality of instantaneous rotations (Rᵢ) for a plurality set of detections from the one or more sensors and the scene tracking system, decompose each of the computed plurality of instantaneous rotations (Rᵢ) into yaw, pitch, and roll components, determine an average yaw component, an average pitch component, and an average roll component based on the decomposed components, and estimate the sensor orientation based on the determined average yaw component, average pitch component, and average roll component.

In an aspect, to estimate the sensor orientation (R), the controller may be configured to compute a centroid for each of a plurality set of detections from the one or more sensors and the scene tracking system, determine a plurality set of non-zero detections based on the computed centroid for each of the plurality set of detections, and estimate the sensor orientation based on the determined plurality set of non-zero detections.

In an aspect, to estimate the sensor position, the controller may be configured to determine a rotation matrix Q_{(θ}_{ᵢ}₎^{T} for a set of yaw, pitch, and roll angles represented in vector θᵢ, and a displacement vector (d) based on the calibration data received from the plurality of fiducial targets and estimate the sensor position based on the determined rotation matrix Q_{(θ}_{ᵢ}₎^{T} and the displacement vector (d).

In an aspect, the controller is configured to transform a point feature from a fiducial coordinate system (FCS) to a tracker coordinate system (TCS).

In an aspect, to calibrate the one or more sensors based on the estimated at least one calibration parameter, the controller is configured to transform a point feature from a sensor coordinate system (SCS) to a unified coordinate system (UCS) based on the estimated at least one calibration parameter.

In an aspect, the sensor calibration system may comprise a plurality of fiducial targets positioned on and around a multiaxis rotary platform and in proximity to the vehicle for calibration.

In an aspect, one or more sensors may be configured to detect both fiducial targets and non-fiducial targets features, such as edges, textures, or patterns, that are present in the calibration environment as the multiaxis rotary platform moves.

In an aspect, the scene tracking system may be configured to monitor, and track both fiducial targets and non-fiducial targets features, such as edges, textures, or patterns, that are present in the calibration environment as the multiaxis rotary platform moves.

In an aspect, the multiaxis rotary platform may incorporate multiple components to enable three-dimensional rotation around the yaw, pitch, and roll axes. These components may include distinct rotational mechanisms such as stacked axes for independent control of yaw, pitch, and roll, gimbal systems for coordinated or sequential motion, a combination of rotary stages and actuators for precise motion control, spherical joint mechanisms for tilt operations, rotary components for yaw, pitch, and roll, or direct-drive motors for independent and precise rotation along each axis.

In an aspect, the second platform may incorporate multiple components to enable three-dimensional tilt around the yaw, pitch, and roll axes. These components may include distinct rotational mechanisms such as stacked axes for independent tilt control along the yaw, pitch, and roll axes, gimbal systems for coordinated or sequential motion, a combination of rotary stages and actuators for precise motion control, spherical joint mechanisms for tilt operations, rotary components for yaw, pitch, and roll, or direct-drive motors for independent and precise tilt along each axis.

The calibration system and associated method of the present disclosure overcome one or more of the shortcomings of the prior art. Additional features and advantages may be realized through the techniques of the present disclosure. Other embodiments and aspects of the disclosure are described in detail herein and are considered a part of the claimed disclosure.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows a block diagram of a sensor calibration system in accordance with some embodiments of the present disclosure.

FIG. 2A shows an example vehicle sensor calibration system in accordance with some embodiments of the present disclosure.

FIG. 2B shows an example multiaxis rotating platform in accordance with some embodiments of the present disclosure.

FIG. 2C shows an example vehicle along with fiducial targets in accordance with some embodiments of the present disclosure.

FIG. 3 shows a block diagram of another exemplary vehicle sensor calibration system in accordance with some embodiments of the present disclosure.

FIG. 4 shows another example vehicle sensor calibration system in accordance with some embodiments of the present disclosure.

FIG. 5 shows a flow diagram of a vehicle sensor calibration method, in accordance with some embodiments of the present disclosure.

FIG. 6 shows a flow diagram of another vehicle sensor calibration method, in accordance with some embodiments of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in the attached drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Unless the context requires otherwise, throughout the specification and claims which follow, the word “comprise” and variations thereof, such as, “comprises” and “comprising” are to be construed in an open, inclusive sense, that is as “including, but not limited to.”

The headings and Abstract of the Disclosure provided herein are for convenience only and do not interpret the scope or meaning of the implementations.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “sensor-equipped unit,” as used in this document and the claims, comprises vehicles such as autonomous vehicles, as well as drones and robots, all of which rely on precise sensor calibration for reliable operation.

The present disclosure describes a sensor calibration system for sensor-equipped units, such as vehicles, that comprises a specialized multiaxis rotating platform designed to accommodate a vehicle. The system incorporates a plurality of fiducial targets, which serve as reference points essential for calibration, strategically positioned on or around the rotating platform. A scene tracking system, connected to the fiducial targets, and the vehicle, is configured to perform precise monitoring and tracking of the positions and movements in three-dimensional space. The core component, a sophisticated controller, interfaces with the sensors, the platform, and the scene tracking system. The controller receives calibration data from the sensors, the platform, and scene tracking system. Using this data, the controller employs algorithms to estimate calibration parameters, subsequently calibrating the sensors based on the derived parameters.

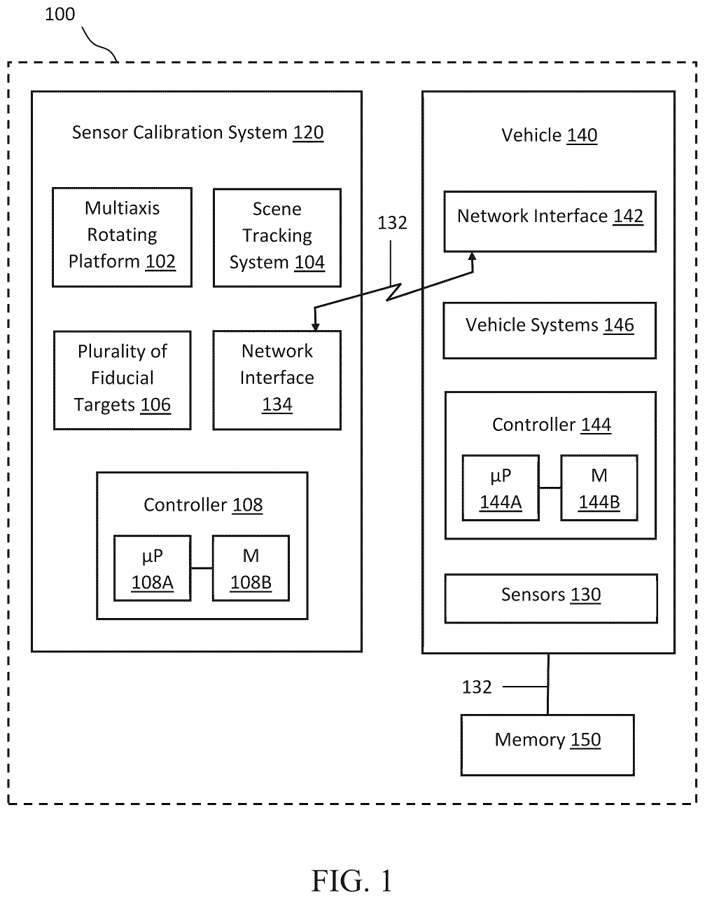

FIG. 1 shows a block diagram of a sensor-equipped system such as an exemplary vehicle system 100 in accordance with some embodiments of the present disclosure. As mentioned above, although the word vehicle is used, any type of sensor-equipped unit may benefit from the teachings including but not limited to robots and drones. As illustrated in FIG. 1, the exemplary vehicle system 100 comprises a sensor calibration system 120 and a vehicle 140 equipped with one or more sensors 130. The sensor calibration system 120 introduces a novel approach to dynamically calibrating the one or more sensors 130, offering greater flexibility in the vehicle 140 placement. Unlike conventional systems, the sensor calibration system 120 enables the placement of vehicle 140 anywhere on the multiaxis rotating platform 102 without restriction to a specific orientation or position. The sensor calibration system 120 comprises a multiaxis rotating platform 102, a scene tracking system 104, a plurality of fiducial targets 106, and a controller 108. The vehicle 140 may be an autonomous vehicle or a non-autonomous vehicle.

The multiaxis rotating platform 102 is a key component that is designed to facilitate dynamic and comprehensive calibration of the one or more sensors 130 mounted on the vehicle 140. In one embodiment, the multiaxis rotating platform 102 comprises a specialized, motorized surface capable of rotating the vehicle 140 in three-dimensions around the yaw, pitch, and roll axes, in a controlled manner during the calibration process. The vehicle 140 is positioned on the multiaxis rotating platform 102.

The multiaxis rotating platform 102 is equipped with the capability to rotate the vehicle 140 smoothly, in three-dimensions around the yaw, pitch, and roll axes, allowing for systematic three-dimensional data collection from the one or more sensors 130 mounted on the vehicle 140. In one embodiment, the multiaxis rotating platform 102 comprises a platform that may rotate 360 degrees in each of the yaw, pitch, and roll component axes, and equipped with various sensors.

The plurality of fiducial targets 106 plays a role in achieving accurate and efficient sensor calibration. In one embodiment, the plurality of fiducial targets 106 refers to multiple identifiable points or targets strategically positioned on or around the vehicle 140. The plurality of fiducial targets 106 plays a role in the calibration process by providing reference points for the scene tracking system 104 to precisely monitor, track and analyze the vehicle movement and orientation. In one embodiment, the plurality of fiducial targets 106 are typically designed to be easily detectable and distinguishable by the scene tracking system 104, ensuring accurate three-dimensional data collection during the calibration procedure. The placement of the plurality of fiducial targets 106 is strategic, covering different areas of the vehicle 140 to capture a comprehensive set of data points during rotation. This distributed arrangement allows the sensor calibration system 120 to triangulate and precisely determine the position and orientation of the vehicle 140 on the multiaxis rotating platform 102.

In one embodiment, the plurality of fiducial targets 106 are passive targets, such as, but not limited to, retroreflective targets, which are commonly used due to their low cost and ease of integration. The fiducial targets 106 reflect light from the scene tracking system 104, providing precise location data. In another embodiment, the plurality of fiducial targets 106 are active targets, such as targets equipped with LEDs or radio transmitters, which may be employed in low-light conditions or environments with high visual clutter. Furthermore, in some embodiments, the fiducial targets 106 may be visual fiducial targets, such as ArUco markers, AprilTags, checkerboards 260, QR codes, circular dot patterns, or ChArUco boards; reflective fiducial targets, such as prisms, corner reflectors 255, corner cube reflectors, spherical retroreflectors, or reflective tape; geometric fiducial targets, such as three-dimensional cones, cylinders, dots, or spheres 250; or radio-frequency identification (RFID) tags or any specialized patterns.

In one embodiment, the one or more sensors 130 include, but are not limited to, cameras (e.g., RGB, depth, or thermal cameras), radar, lidar, inertial measurement units (IMUs), ultrasonic sensors, laser scanners, structured light sensors, optical sensors or time-of-flight sensors. These sensors may work in conjunction to capture data across multiple modalities, improving calibration accuracy through sensor fusion. The combination of fiducial targets 106 and one or more sensors 130 ensures robust calibration of the system under varying environmental conditions, such as changes in lighting, cluttered backgrounds, or sensor occlusions.

The scene tracking system 104 in the sensor calibration system 120 plays a role in capturing the data and features from the plurality of fiducial targets 106 and the vehicle 140. In some embodiments, the scene tracking system 104 may be vision-based equipment such as cameras (including stereo cameras for 3D depth perception) that are commonly used as they offer a non-contact approach and may track the plurality of fiducial targets 106 over a wider field of view. In some other embodiments, the scene tracking system 104 may be laser-based equipment such as LiDAR scanners and laser trackers that provide high-precision measurements by emitting laser pulses and measuring their reflections from the plurality of fiducial targets 106. In some other embodiments, the scene tracking system 104 may be radar-based equipment.

In some embodiments, the scene tracking system 104 may be a robotic total station. In such embodiments, the scene tracking system 104 is strategically positioned or mounted to enable comprehensive coverage of the multiaxis rotating platform 102 and vehicle 140, ensuring optimal tracking of the plurality of fiducial targets 106 and features of the vehicle 140. The scene tracking system 104 may employ advanced surveying technologies, including laser-based measurements and automated movements, to continuously monitor the spatial dynamics of the targets during the vehicle's 140 rotation. As the multiaxis rotating platform 102 undergoes motion, the scene tracking system 104 dynamically adjusts its orientation and focal points to capture real-time data points from the plurality of fiducial targets 106. This data, transmitted to the controller 108, becomes integral for the estimation of calibration parameters such as sensor orientation and position.

In one embodiment, the scene tracking system 104 is configured to accurately identify and distinguish individual targets and features of vehicle 140 amidst potential background noise or clutter by employing image processing and signal analysis techniques. By tracking the targets' movements and the vehicle 140 in real-time when the multiaxis rotating platform 102 is moving, the scene tracking system 104 calculates the precise position and orientation of the vehicle 140 with respect to the plurality of fiducial targets 106, which forms a basis for sensor calibration calculations. Further, the scene tracking system 104 seamlessly communicates with the controller 108, transmitting all captured data in a synchronized manner, thereby ensuring an accurate correlation between the data from the scene tracking system 104 and the one or more sensors 130 that are received by the controller 108.

The controller 108 plays a role in facilitating precise and reliable calibration. The heart of the sensor calibration system 120 lies in its advanced and intricately designed controller 108. This central component serves as the linchpin in orchestrating the seamless calibration of the vehicle's sensors 130, ensuring accuracy and reliability in diverse operational scenarios. In one embodiment, the calibration parameters determined by the controller 108 are transmitted to the vehicle 140 over a network 132 through a network interface 134 in the sensor calibration system 120 and a network interface 142 in the vehicle 140. A controller 144 is provided in the vehicle 140 to control one or more vehicle systems 146. The vehicle systems 146 include but are not limited to autonomous vehicle operating system, collision avoidance system, active braking system, cross-traffic warning systems, blind spot warning systems, automatic trailering systems, automatic parking systems, attitude control systems for drones, weapons deployment for drones, robotic arm guidance systems, and robot guidance systems. The controller 144 may comprise at least one processor 144A in communication with at least one non-transitory processor-readable medium 144B. The processor-readable medium 144B may have instructions stored thereon which when executed cause the processors to perform or control performance of the operations as described herein. Furthermore, in some examples, the controller 144 or its functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof.

The calibration parameters received through the network interfaces 134 and 142 are stored in a memory device or computer readable medium 144B either within the vehicle 140 or in an external memory device 150 that is operatively connected to the vehicle 140 via the network 132. The stored calibration parameters are used during the operation of the vehicle system 146 to ensure optimal performance and accurate sensor data. This system allows for efficient storage and retrieval of calibration information, facilitating real-time adjustments and enhancing the overall effectiveness of the sensor calibration process to improve the accuracy of the operation of the vehicle systems 146.

In one embodiment, the controller 108 is operatively coupled to the one or more sensors 130, the multiaxis rotating platform 102, and the scene tracking system 104 via the wired or wireless network 132. The network connectivity allows the controller 108 to receive calibration data from the various components, enabling it to perform the calibration process regardless of the controller's physical location relative to the vehicle 140. This configuration provides flexibility, allowing the calibration process to take place at different locations within the system's operational environment.

In an embodiment, the controller 108 is designed to operate in real time, processing calibration data as it is received from the sensors 130, the multiaxis rotating platform 102, and the scene tracking system 104. Alternatively, the calibration data may be stored in a memory device 108B for subsequent processing, enabling the controller 108 to compute the calibration parameters at a later time, if necessary. This adaptable approach ensures that the calibration process remains efficient, accurate, and optimized for system performance in varying operational conditions.

In some examples, the controller 108 may comprise at least one processor 108A in communication with at least one non-transitory processor-readable medium 108B. The processor-readable medium 108B may have instructions stored thereon which when executed cause the processors to perform or control performance of the operations as described herein. Furthermore, in some examples, the controller 108 or its functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors 108A (e.g., microprocessors, central processing units, graphical processing units), as firmware, and the like, or as a combination thereof.

In one embodiment, to ease the calibration procedure, the controller 108 is configured to transform points in the fiducial coordinate system (FCS) into the tracker coordinate system (TCS) before the calibration process begins. In order to perform the transformation, sample features on the plurality of fiducial targets 106 are observed from scene tracking system 104. Later, based on the observation, the controller 108 performs the rigid transformation between the FCS and the TCS.

In one embodiment, the one or more sensors 130 on the vehicle 140 detect and capture data related to both the plurality of fiducial targets 106 (fiducial target data) and non-fiducial target features in the environment, such as edges, textures, or patterns. This detection provides valuable information to the controller 108 about the spatial orientation and position of both the fiducials and the non-fiducial target features in the vehicle's environment. The fiducials and non-fiducial target features together act as reference points, enabling the sensor calibration system 120 to determine the relationship between the sensor data and the motion of the multiaxis rotating platform 102.

In one embodiment, the scene tracking system 104 monitor, and track data related to both the plurality of fiducial targets 106 (fiducial target data) and non-fiducial target features in the environment, such as edges, textures, or patterns. This detection provides valuable information to the controller 108 about the spatial orientation and position of both the fiducials and the non-fiducial target features in the vehicle's environment. The fiducials and non-fiducial target features together act as reference points, enabling the sensor calibration system 120 to determine the relationship between the data from the scene tracking system 104 and the motion of the multiaxis rotating platform 102.

The calibration data obtained from the plurality of fiducial targets 106 and non-fiducial target features in the environment contributes to the estimation of calibration parameters, including rotation and orientation parameters, such as sensor orientation (R), and translation and position parameters, such as sensor position (t). The calibration process may also involve a scale factor to normalize sensor outputs and time synchronization offsets for coordinating data from multiple sensors. By detecting the plurality of fiducial targets 106 during the rotation of the multiaxis rotating platform 102, the sensor calibration system 120 can adapt to different scenarios and variations in the placement of the vehicle 140. This adaptability is particularly useful when calibrating the one or more sensors 130 on the vehicle 140 with diverse spatial configurations, ensuring that the calibration is accurate across various sensor types, orientations, and operational conditions.

In order to perform the calibration, the controller is configured to utilize the relationship between coordinate systems such as a unified coordinate system (UCS), a sensor coordinate system (SCS) and a tracker coordinate system (TCS). The relationship between the UCS and SCS is shown in equation (1).

$${D}_{i}^{UCS} = R {D}_{i}^{SCS} + t {1}^{T} \qquad ( 1 )$$

where Dᵢ^{UCS} represents a point set representation as observed in the UCS at time stamp i,
Dᵢ^{SCS} represents a point set representation as observed in the SCS at time stamp i,
R represents a sensor orientation,
t represents a sensor position, and
1^{T} represents a transpose of all-ones column vector.

Further, the relationship between the UCS and TCS is shown in equation (2),

$${D}_{i}^{UCS} = {Q}_{( {θ}_{i} )} ( {D}_{i}^{TCS} + d {1}^{T} ) \qquad ( 2 )$$

where Dᵢ^{TCS} represents a point set representation as observed in the TCS at time stamp i,
θᵢ represents a vector of yaw, pitch, and roll rotation angle components of the multiaxis rotating platform at time stamp i,
Q_{(θ}_{ᵢ}₎ represents a three-dimensional rotation matrix constructed based on the vector of angles θᵢ,
d represents a vector that displaces the TCS from the UCS when θᵢ is a vector of zero-degree angles.

In one embodiment, the controller 108 is configured to receive and process calibration data from the one or more sensors 130, multiaxis rotating platform 102, and the scene tracking system 104. The controller 108 is further configured to dynamically adapt the calibration process based on the specific configuration of the sensors, accounting for variations in sensor types, positions, orientations, and fields of view. To enhance the accuracy of the calibration parameters, the controller utilizes sensor fusion techniques, such as Kalman filtering, Bayesian fusion, or neural network-based signal processing. These sophisticated algorithms are tailored to integrate data from diverse sensor formats, ensuring the system remains versatile and adaptable across a wide range of sensor configurations and calibration scenarios.

Further, the controller 108 is configured to estimate the calibration parameters that define the orientation and position of the one or more sensors 130. These parameters, comprising sensor orientation (R) and sensor position (t), play a pivotal role in the subsequent calibration process. The controller 108 engages advanced mathematical models and algorithms to precisely estimate these parameters, laying the foundation for accurate sensor readings and data fusion.

In one embodiment, the controller 108 utilizes the relation between three coordinate systems, as mentioned in equations 1 and 2, and re-arranges them as shown in equation 3,

$$R {D}_{i}^{SCS} - {Q}_{( {θ}_{i} )} {D}_{i}^{TCS} + ( t - {Q}_{( {θ}_{i} )} d ) {1}^{T} = {01}^{T} \qquad ( 3 )$$

where 0 represents a column vector of all zeros.

In one embodiment, in order to compute the sensor orientation (R), the controller 108 is configured to compute a plurality of instantaneous rotations (Rᵢ) for a plurality set of detections from the one or more sensors 130 and the scene tracking system 104. For example, each set of detections may be represented as {Dᵢ^{SCS}, Dᵢ^{TCS}} where i ranges from 0 to n time instants.

In some embodiments, each of the plurality of instantaneous rotations (Rᵢ) may be computed using the equation 4,

$${\hat{R}}_{i} , {\hat{h}}_{i} = {arg}_{R ,} {min}_{{h}_{i}} {‖ {RD}_{i}^{SCS} - {Q}_{( {θ}_{i} )} {D}_{i}^{TCS} + {h}_{i} {1}^{T} ‖}_{F}^{2} \qquad ( 4 )$$

where hᵢ=t−Q_{(θ}_{ᵢ}₎d

Upon computing the instantaneous rotation (Rᵢ), the controller 108 is configured to decompose each of the computed plurality of instantaneous rotations (Rᵢ) into pitch, yaw, and roll components.

Further, the controller 108 is configured to determine an average yaw component, an average pitch component, and an average roll component based on the decomposed components and estimate the sensor orientation (R) based on the determined average yaw component, average pitch component, and average roll component.

In another embodiment, in order estimate the sensor orientation (R), the controller 108 is configured to compute a centroid for each of a plurality set of detections from the one or more sensors 130 and the scene tracking system 104 and determine a plurality set of non-zero detections based on the computed centroid for each of the plurality set of detections. In order to determine the non-zero detections, the controller 108 is configured to remove the centroid from each set of the plurality set of detections. For example, each set of non-zero detections may be represented as {D₀ᵢ^{SCS}, D₀ᵢ^{SCS}} where i ranges from 0 to n time instants. Also, for example, a set of non-zero detections in SCS may be represented in D₀ᵢ^{SCS}={D₀ᵢ^{SCS}} and a set of non-zero detections in TCS may be represented in D₀ᵢ^{SCS}={D₀ᵢ^{SCS}} where i ranges from 0 to n time instants. Upon determining the plurality set of non-zero detections, the controller 108 is configured to estimate the sensor orientation (R) based on the determined plurality set of non-zero detections using the equation (5).

$$\hat{R} = {arg min}_{R} {‖ {RD}_{0}^{SCS} - {D}_{0}^{TCS} ‖}_{F}^{2} \qquad ( 5 )$$

In one embodiment, to compute the sensor position (t), the controller 108 is configured to determine a rotation matrix Q_{(θ}_{ᵢ}₎and a displacement vector (d) based on calibration data received from the scene tracking system 104. In one embodiment, the calibration data comprises a vector θᵢ of yaw, pitch, and roll rotation angle components of multiaxis rotating platform 102 at the ith time stamp. Using θᵢ, the controller computes Q_{(θ}_{ᵢ}₎. The displacement vector (d) is determined by solving the relationship,

$${\hat{h}}_{i} \approx t - {Q}_{( {θ}_{i} )} d \qquad ( 6 )$$

where hᵢ is obtained using eq. (4).

In one embodiment, for multiple timestamps, the relationship is extended into a matrix form as,

$$\hat{H} \approx t {1}^{T} - {J}_{( d )} \qquad ( 7 )$$

where H contains multiple hₗ data points over n timesteps and J_{(d)} encodes the effect of the multiaxis rotating platform's Q_{(θ}_{ᵢ}₎ rotation on the displacement vector d.

In one embodiment, the controller 108 estimates d by minimizing the Frobenius norm, expressed as,

$$\hat{d} = {arg min}_{d} {‖ cov ( \hat{H} ) - cov ( {J}_{( d )} ) ‖}_{F}^{2} \qquad ( 8 )$$

where cov( ) means a covariance operation.

In one embodiment, once d is determined, the controller 108 calculates the sensor position t as the average of individual sensor position estimates tₗ where,

$${\hat{t}}_{i} = {\hat{h}}_{i} + {Q}_{( {θ}_{i} )} \hat{d} \qquad ( 9 )$$

Further, the controller 108 is configured to calibrate the one or more sensors 130 based on the estimated calibration parameters. In one embodiment, the controller 108 is configured to calibrate the one or more sensors 130 by transforming point features and sensor data from the SCS to the UCS based on the sensor orientation (R) and the sensor position (t) using the eq. (1). Further, in some embodiments, the controller 108 is configured to validate the calibrated one or more sensors 130 to ensure that the calibration results are accurate and reliable. In one embodiment, the validation may be performed by comparing sensor readings to known fiducial positions after the calibration. In some embodiments, the controller 108 also coordinates with the plurality of fiducial targets 106 that are strategically positioned on and around the multiaxis rotating platform 102.

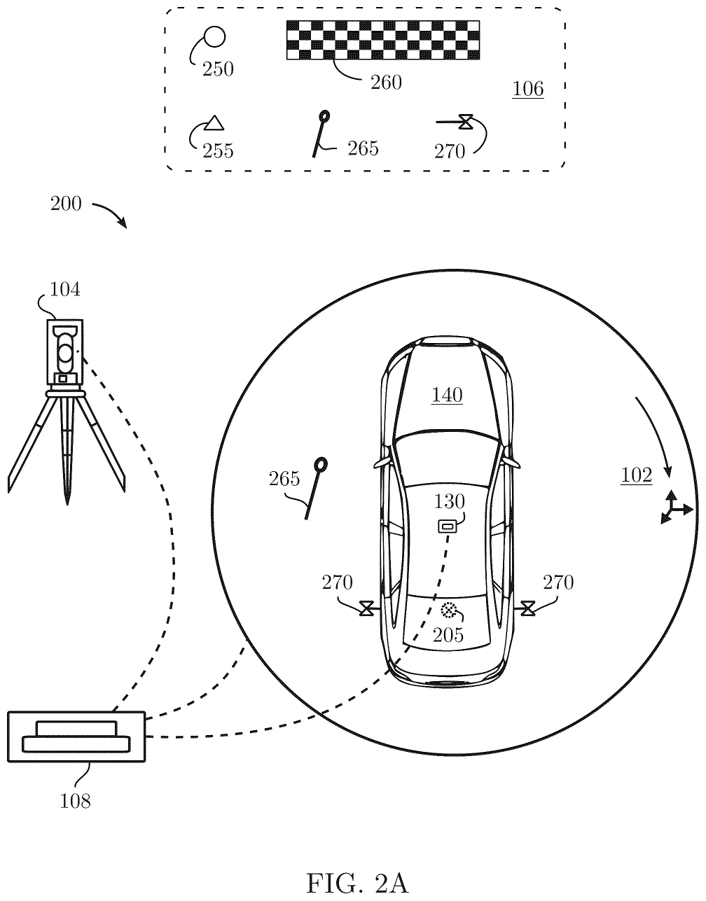

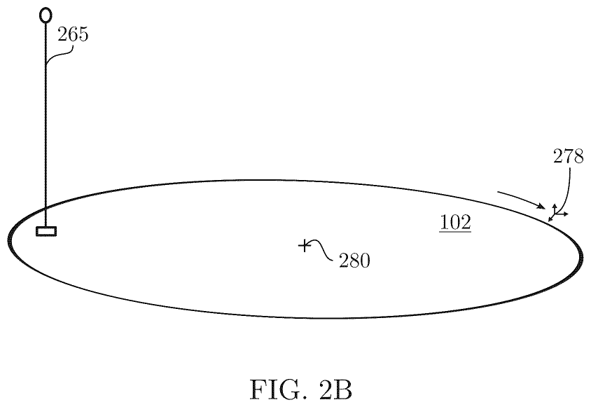

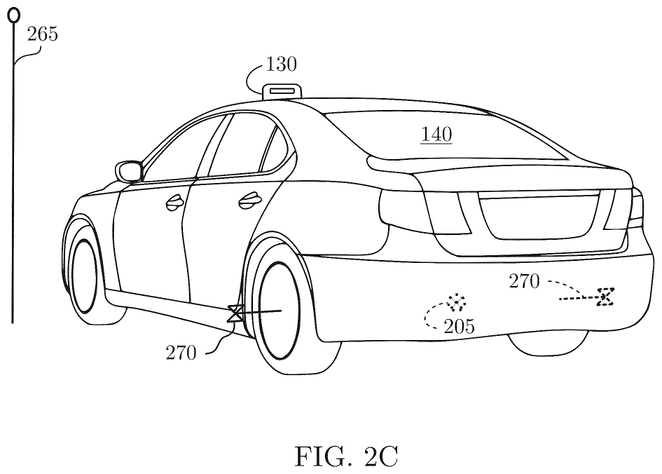

FIG. 2A shows an illustration of the example vehicle system 100 in a calibration environment 200 in accordance with some embodiments of the present disclosure. As shown in FIG. 2A, the vehicle 140 is equipped with the one or more sensors 130, which require calibration to ensure accurate and precise measurements and data fusion. The coordinate system associated with the vehicle 140 is referred to as the unified coordinate system (UCS) 205. The UCS 205 serves as a chosen coordinate system for calibration purposes, and calibration parameters are determined with respect to this system. A plurality of fiducial targets 106 are positioned on and around the rotating platform 102. The fiducial targets 265, 270 positioned on the rotating platform 102 rotate with the platform. In one embodiment, a pair of fiducial targets 270 is strategically positioned on the vehicle to determine the position and orientation of the center of a unified coordinate system 205 on the vehicle. For instance, each pair of the fiducial targets 270 can be positioned at the center of the rear wheel of the vehicle 140 if the unified coordinate system 205 is defined in the rear axle of the vehicle 140. In another embodiment, the position and orientation of the center of a unified coordinate system (UCS) 205 on the vehicle is dynamically determined by matching the visual features of the vehicle, which is tracked by the scene tracking system 104, with a three-dimensional model of the vehicle. In another embodiment, the position and orientation of the unified coordinate system 205 is at any conveniently chosen location.

Further, as shown in FIG. 2A, the vehicle 140 is positioned on the multiaxis rotating platform 102. As there is no specific requirement for the vehicle 140 to be placed in a particular heading or orientation on the multiaxis rotating platform 102, the sensor calibration system 120 offering flexibility in the vehicle 140 placement. Further, a pair of fiducial targets 270 are mounted directly on the vehicle 140 in relation to the unified coordinate system (UCS 205). In one embodiment, mounting brackets or clamps are used to secure the pair of fiducial targets 270 in place.

FIG. 2B shows an example multiaxis rotating platform 102 in accordance with some embodiments of the present disclosure. As shown in FIG. 2B, the multiaxis rotating platform 102 stands as a versatile platform at the forefront of precise measurements and controlled rotations. At its core, the multiaxis rotating platform 102 is configured to rotate in all three dimensions 278 around the pitch axis, yaw axis, and roll axis of motion centered around the center 280 of the rotating platform 102. The multiaxis rotating platform 102 operates in both motorized and unmotorized modes, offering flexibility in usage. Further, the fiducial target 265 may be affixed to or floating on the multiaxis rotating platform 102. The fiducial target 265 may be checkerboard, corner reflector, sphere, prism, fiducial marker, camera, radar, lidar, IMU, GNSS (GPS), ultrasonic sensor, time-of-flight sensor, odometer, infrared sensor, capacitive sensor, wheel and rotation sensor, and weight sensor. Further, the position of the fiducial target 265 may vary, being located on the surface, floating above, or embedded within the multiaxis rotating platform 102.

FIG. 2C shows an example vehicle 140 along with fiducial targets 265, 270 in accordance with some embodiments of the present disclosure. As shown in FIG. 2C, the vehicle 140 along with the fiducial targets 265, 270 is provided such that an imaginary line joining the pair of fiducial targets 270 passes through the unified coordinate system (UCS 205). Further, the pair of fiducial targets 270 are provided using mounting brackets or clamps. In another embodiment, the pair of fiducial targets 270 are not required to localize UCS 205. Instead, UCS 205 is localized through signal processing and image processing techniques, including point set registration and matching the visual features of vehicle 140, which is tracked by scene tracking system 104, with a three-dimensional model of the vehicle.

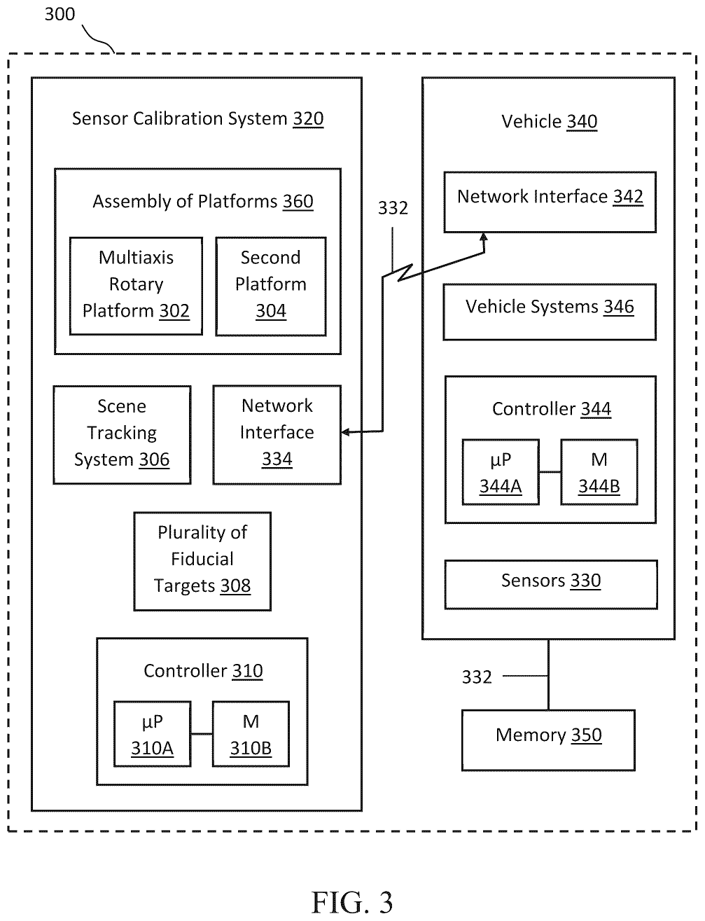

FIG. 3 shows a block diagram of another sensor-equipped system such as an exemplary vehicle system 300 in accordance with some embodiments of the present disclosure. As mentioned above, although the word vehicle is used, any type of sensor-equipped unit may benefit from the teachings including but not limited to robots and drones. As illustrated in FIG. 3, the exemplary vehicle system 300 comprises a sensor calibration system 320 and a vehicle 340 equipped with one or more sensors 330. The sensor calibration system 320 introduces a novel approach to dynamically calibrating the one or more sensors 330, offering greater flexibility in vehicle placement. Unlike conventional systems, the sensor calibration system 320 enables the placement of vehicle 340 anywhere on a second platform 304 without restriction to a specific orientation. The sensor calibration system 320 comprises an assembly of platforms 360, a scene tracking system 306, a plurality of fiducial targets 308, and a controller 310. The assembly of platforms 360 comprises a multiaxis rotary platform 302 and the second platform 304. The second platform 304 is a non-rotating platform. The vehicle 340 may be an autonomous vehicle or a non-autonomous vehicle. The exemplary sensor calibration system 320 is particularly suited for calibration scenarios where the vehicle is not to be rotated.

The assembly of platforms 360 is a key component that is designed to facilitate dynamic and comprehensive calibration of the one or more sensors 330 mounted on the vehicle 340. In one embodiment, the multiaxis rotary platform 302 comprises a specialized, motorized surface capable of rotating the vehicle 340 in three-dimensions around the yaw, pitch, and roll axes, in a controlled manner during the calibration process. The multiaxis rotary platform 302 rotates around the second platform 304. The vehicle 340 is positioned on the second platform 304.

The plurality of fiducial targets 308 plays a role in achieving accurate and efficient sensor calibration. In one embodiment, the plurality of fiducial targets 308 refers to multiple identifiable points or targets strategically positioned on or around the vehicle 340. The plurality of fiducial targets 308 plays a role in the calibration process by providing reference points for the scene tracking system 306 to precisely monitor, track and analyze the vehicle's movement and orientation. In one embodiment, the plurality of fiducial targets 308 are typically designed to be easily detectable and distinguishable by the scene tracking system 306, ensuring accurate three-dimensional data collection during the calibration procedure. The placement of the plurality of fiducial targets 308 is strategic, covering different areas of the vehicle 340 to capture a comprehensive set of data points during rotation. This distributed arrangement allows the sensor calibration system 320 to triangulate and precisely determine the position and orientation of the vehicle 340 on the second platform 304.

In one embodiment, the plurality of fiducial targets 308 are passive targets, such as, but not limited to, retroreflective targets, which are commonly used due to their low cost and ease of integration. The fiducial targets 308 reflect light from the scene tracking system 306, providing precise location data. In another embodiment, the plurality of fiducial targets 308 are active targets, such as targets equipped with LEDs or radio transmitters, which may be employed in low-light conditions or environments with high visual clutter. Furthermore, in some embodiments, the fiducial targets 308 may be visual fiducial targets, such as ArUco markers, AprilTags, checkerboards 460, QR codes, circular dot patterns, or ChArUco boards; reflective fiducial targets, such as prisms, corner reflectors 455, corner cube reflectors, spherical retroreflectors, or reflective tape; geometric fiducial targets, such as three-dimensional cones, cylinders, dots, or spheres 450; or radio-frequency identification (RFID) tags or any specialized patterns.

In one embodiment, the one or more sensors 330 include, but are not limited to, cameras (e.g., RGB, depth, or thermal cameras), radar, lidar, inertial measurement units (IMUs), ultrasonic sensors, laser scanners, structured light sensors, optical sensors or time-of-flight sensors. These sensors may work in conjunction to capture data across multiple modalities, improving calibration accuracy through sensor fusion. The combination of fiducial targets 308 and one or more sensors 330 ensures robust calibration of the system under varying environmental conditions, such as changes in lighting, cluttered backgrounds, or sensor occlusions.

The scene tracking system 306 in the sensor calibration system 320 plays a role in capturing the data and features from the plurality of fiducial targets 308 and the vehicle 340. In some embodiments, the scene tracking system 306 may be vision-based equipment such as cameras (including stereo cameras for 3D depth perception) that are commonly used as they offer a non-contact approach and may track the plurality of fiducial targets 308 over a wider field of view. In some other embodiments, the scene tracking system 306 may be laser-based equipment such as LiDAR scanners and laser trackers that provide high-precision measurements by emitting laser pulses and measuring their reflections from the plurality of fiducial targets 308. In some other embodiments, the scene tracking system 306 may be radar-based equipment.

In some embodiments, the scene tracking system 306 may be a robotic total station. In such embodiments, the scene tracking system 306 is strategically positioned or mounted to enable comprehensive coverage of the assembly of platforms 360 and vehicle 340, ensuring optimal tracking of the plurality of fiducial targets 308 and features of the vehicle 340. The scene tracking system 306 may employ advanced surveying technologies, including laser-based measurements and automated movements, to continuously monitor the spatial dynamics of the targets during the vehicle's 340 rotation. As components of the assembly of platforms 360 undergoes motion, the scene tracking system 306 dynamically adjusts its orientation and focal points to capture real-time data points from the plurality of fiducial targets 308. This data, transmitted to the controller 310, becomes integral for the estimation of calibration parameters such as sensor orientation and position.

In one embodiment, the scene tracking system 306 is configured to accurately identify and distinguish individual targets and features of vehicle 340 amidst potential background noise or clutter by employing image processing and signal analysis techniques. By tracking the targets' movements in real-time when components of the assembly of platforms 360 are moving, the scene tracking system 306 calculates the precise position and orientation of the vehicle 340 with respect to the plurality of fiducial targets 308, which forms a basis for sensor calibration calculations. Further, the scene tracking system 306 seamlessly communicates with the controller 310, transmitting all captured data in a synchronized manner, thereby ensuring an accurate correlation between the data from the scene tracking system 306 and the one or more sensors 330 that are received by the controller 310.

The controller 310 plays a role in facilitating precise and reliable calibration. The heart of the sensor calibration system 320 lies in its advanced and intricately designed controller 310. This central component serves as the linchpin in orchestrating the seamless calibration of the vehicle's sensors 330, ensuring accuracy and reliability in diverse operational scenarios.

In one embodiment, the calibration parameters determined by the controller 310 are transmitted to the vehicle 340 over a network 332 through a network interface 334 in the sensor calibration system 320 and a network interface 342 in the vehicle 340. A controller 344 is provided in the vehicle 340 to control one or more vehicle systems 346. The vehicle systems 346 include but are not limited to autonomous vehicle operating system, collision avoidance system, active braking system, cross-traffic warning systems, blind spot warning systems, automatic trailering systems, automatic parking systems, attitude control systems for drones, weapons deployment for drones, robotic arm guidance systems, and robot guidance systems. The controller 344 may comprise at least one processor 344A in communication with at least one non-transitory processor-readable medium 344B. The processor-readable medium 344B may have instructions stored thereon which when executed cause the processors to perform or control performance of the operations as described herein. Furthermore, in some examples, the controller 344 or its functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof.

The calibration parameters received through the network interfaces 334 and 342 are stored in a memory device or computer readable medium 344B either within the vehicle 340 or in an external memory device 350 that is operatively connected to the vehicle 340 via the network 332. The stored calibration parameters are used during the operation of the vehicle to ensure optimal performance and accurate sensor data. This system allows for efficient storage and retrieval of calibration information, facilitating real-time adjustments and enhancing the overall effectiveness of the sensor calibration process to improve the accuracy of the operation of the vehicle systems 346.

In one embodiment, the controller 310 is operatively coupled to the one or more sensors 330, the assembly of platforms 360, and the scene tracking system 306 via a wired or wireless network. This network connectivity allows the controller 310 to receive calibration data from the various components, enabling it to perform the calibration process regardless of the controller's physical location relative to the vehicle 340. This configuration provides flexibility, allowing the calibration process to take place at different locations within the system's operational environment.

In an embodiment, the controller 310 is designed to operate in real time, processing calibration data as it is received from the sensors 330, the assembly of platforms 360, and the scene tracking system 306. Alternatively, the calibration data may be stored in a memory device for subsequent processing, enabling the controller 310 to compute the calibration parameters at a later time, if necessary. This adaptable approach ensures that the calibration process remains efficient, accurate, and optimized for system performance in varying operational conditions.

In some examples, the controller 310 may comprise at least one processor 310A in communication with at least one non-transitory processor-readable medium 310B. The processor-readable medium 310A may have instructions stored thereon which when executed cause the processors to perform or control performance of the operations as described herein. Furthermore, in some examples, the controller 310 or its functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof.

In one embodiment, to ease the calibration procedure, the controller 310 is configured to transform points in the fiducial coordinate system (FCS) into the tracker coordinate system (TCS) before the calibration process begins. In order to perform the transformation, sample features on the plurality of fiducial targets 308 are observed from scene tracking system 306. Later, based on the observation, the controller 310 performs the rigid transformation between the FCS and the TCS.

In one embodiment, the one or more sensors 330 on the vehicle 340 detect and capture data related to both the plurality of fiducial targets 308 (fiducial target data) and non-fiducial target features in the environment, such as edges, textures, or patterns. This detection provides valuable information to the controller 310 about the spatial orientation and position of both the fiducials and the non-fiducial target features in the vehicle's environment. The fiducials and non-fiducial target features together act as reference points, enabling the sensor calibration system 320 to determine the relationship between the sensor data and the motion of the assembly of platforms 360.

In one embodiment, the scene tracking system 306 monitor, and track data related to both the plurality of fiducial targets 308 (fiducial target data) and non-fiducial target features in the environment, such as edges, textures, or patterns. This detection provides valuable information to the controller 310 about the spatial orientation and position of both the fiducials and the non-fiducial target features in the vehicle's environment. The fiducials and non-fiducial target features together act as reference points, enabling the sensor calibration system 320 to determine the relationship between the data from the scene tracking system 306 and the motion of the assembly of platforms 360.

The calibration data obtained from the plurality of fiducial targets 308 and non-fiducial target features in the environment contributes to the estimation of calibration parameters, including rotation and orientation parameters, such as sensor orientation (R), and translation and position parameters, such as sensor position (t). The calibration process may also involve a scale factor to normalize sensor outputs and time synchronization offsets for coordinating data from multiple sensors. By detecting the plurality of fiducial targets 308 during the rotation of components of the assembly of platforms 360, the sensor calibration system 320 can adapt to different scenarios and variations in the placement of the vehicle 340. This adaptability is particularly useful when calibrating the one or more sensors 330 on the vehicle 340 with diverse spatial configurations, ensuring that the calibration is accurate across various sensor types, orientations, and operational conditions.

In order to perform the calibration, the controller is configured to utilize the relationship between coordinate systems such as a unified coordinate system (UCS), a sensor coordinate system (SCS) and a tracker coordinate system (TCS). The relationship between the UCS and SCS is shown in equation (10) as,

$${D}_{i}^{UCS} = R {D}_{i}^{SCS} + t {1}^{T} \qquad ( 10 )$$

where Dᵢ^{SCS} represents a point set representation as observed in the UCS at time stamp i,
Dᵢ^{SCS} represents a point set representation as observed in the SCS at time stamp i,
R represents a sensor orientation,
t represents a sensor position, and
1^{T} represents a transpose of all-ones column vector.

Further, the relationship between the UCS and TCS is shown in equation (11) as,

$${D}_{i}^{UCS} = {Q}_{( {θ}_{i} )}^{T} ( {D}_{i}^{TCS} + d {1}^{T} ) \qquad ( 11 )$$

where Dᵢ^{TCS} represents a point set representation as observed in the TCS at time stamp i,
θᵢ represents a vector of yaw, pitch, and roll rotation angle components of the multiaxis rotary platform at time stamp i,
Q_{(θ}_{ᵢ}₎^{T} represents the transpose of a three-dimensional rotation matrix constructed based on the vector of angles θᵢ,
d represents a vector that displaces the TCS from the UCS when θᵢ is a vector of zero-degree angles.

In one embodiment, the controller 310 is configured to receive and process calibration data from the one or more sensors 330, multiaxis rotary platform 302, and the scene tracking system 306. The controller 310 is further configured to dynamically adapt the calibration process based on the specific configuration of the sensors, accounting for variations in sensor types, positions, orientations, and fields of view. To enhance the accuracy of the calibration parameters, the controller utilizes sensor fusion techniques, such as Kalman filtering, Bayesian fusion, or neural network-based signal processing. These sophisticated algorithms are tailored to integrate data from diverse sensor formats, ensuring the system remains versatile and adaptable across a wide range of sensor configurations and calibration scenarios.

Further, the controller 310 is configured to estimate the calibration parameters that define the orientation and position of the one or more sensors 330. These parameters, comprising sensor orientation (R) and sensor position (t), play a pivotal role in the subsequent calibration process. The controller 310 engages advanced mathematical models and algorithms to precisely estimate these parameters, laying the foundation for accurate sensor readings and data fusion.

In one embodiment, the controller 310 utilizes the relation between three coordinate systems, as mentioned in equations 10 and 11, and re-arranges them as shown in equation 12 as

$$R {D}_{i}^{SCS} - {Q}_{( {θ}_{i} )}^{T} {D}_{i}^{TCS} + ( t - {Q}_{( {θ}_{i} )}^{T} d ) {1}^{T} = {01}^{T} \qquad ( 12 )$$

where 0 represents a column vector of all zeros.

In one embodiment, in order to compute the sensor orientation (R), the controller 310 is configured to compute a plurality of instantaneous rotations (Rᵢ) for a plurality set of detections from the one or more sensors 330 and the scene tracking system 306. For example, each set of detections may be represented as {Dᵢ^{SCS}, Dᵢ^{TCS}} where i ranges from 0 to n time instants.

In some embodiments, each of the plurality of instantaneous rotations (Rᵢ) may be computed using the equation 13 as

$${\hat{R}}_{i} , {\hat{h}}_{i} = {arg min}_{R , {\hat{h}}_{i}} {‖ R {D}_{i}^{SCS} - {Q}_{( {θ}_{i} )}^{T} {D}_{i}^{TCS} + {h}_{i} {1}^{T} ‖}_{F}^{2} \qquad ( 13 )$$

where hᵢ=t−Q_{(θ}_{ᵢ}₎^{T}d

Upon computing the instantaneous rotation (Rᵢ), the controller 310 is configured to decompose each of the computed plurality of instantaneous rotations (Rᵢ) into pitch, yaw, and roll components.

Further, the controller 310 is configured to determine an average yaw component, an average pitch component, and an average roll component based on the decomposed components and estimate the sensor orientation (R) based on the determined average yaw component, average pitch component, and average roll component.

In another embodiment, in order estimate the sensor orientation (R), the controller 310 is configured to compute a centroid for each of a plurality set of detections from the one or more sensors 330 and the scene tracking system 306 and determine a plurality set of non-zero detections based on the computed centroid for each of the plurality set of detections. In order to determine the non-zero detections, the controller 310 is configured to remove the centroid from each set of the plurality set of detections. For example, each set of non-zero detections may be represented as {D₀ᵢ^{SCS}, D₀ᵢ^{TCS}} where i ranges from 0 to n time instants. Also, for example, a set of non-zero detections in SCS may be represented in D₀^{SCS}={D₀ᵢ^{SCS}} and a set of non-zero detections in TCS may be represented in D₀^{TCS}={D₀ᵢ^{TCS}} where i ranges from 0 to n time instants. Upon determining the plurality set of non-zero detections, the controller 310 is configured to estimate the sensor orientation (R) based on the determined plurality set of non-zero detections using the equation (14).

$$\hat{R} = {arg min}_{R} {‖ R {D}_{0}^{SCS} - {D}_{0}^{TCS} ‖}_{F}^{2} \qquad ( 14 )$$

In one embodiment, to compute the sensor position (t), the controller 310 is configured to determine a rotation matrix Q_{(θ}_{ᵢ}₎^{T} and a displacement vector (d) based on calibration data received from the scene tracking system 306. In one embodiment, the calibration data comprises a vector θᵢ of yaw, pitch, and roll rotation angle components of multiaxis rotary platform 302 at the ith time stamp. Using θᵢ, the controller computes Q_{(θ}_{ᵢ}₎^{T}. The displacement vector (d) is determined by solving the relationship:

$${\hat{h}}_{i} \approx t - {Q}_{( {θ}_{i} )}^{T} d \qquad ( 15 )$$

where hₗ is obtained using eq. (13).

In one embodiment, for multiple timestamps, the relationship is extended into a matrix form as:

$$\hat{H} \approx t {1}^{T} - {J}_{( d )} \qquad ( 16 )$$

where H contains multiple hᵢ data points over n timesteps and J_{(d)} encodes the effect of the multiaxis rotary platform's Q_{(θ}_{ᵢ}₎^{T} rotation on the displacement vector d.

In one embodiment, the controller 310 estimates d by minimizing the Frobenius norm, expressed as:

$$\hat{d} = {arg min}_{d} {‖ cov ( \hat{H} ) - cov ( {J}_{( d )} ) ‖}_{F}^{2} \qquad ( 17 )$$

where cov( ) means a covariance operation.

In one embodiment, once d is determined, the controller 310 calculates the sensor position t as the average of individual sensor position estimates f where:

$${\hat{t}}_{i} = {\hat{h}}_{i} + {Q}_{( {θ}_{i} )}^{T} \hat{d} \qquad ( 18 )$$

Further, the controller 310 is configured to calibrate the one or more sensors 330 based on the estimated calibration parameters. In one embodiment, the controller 310 is configured to calibrate the one or more sensors 330 by transforming point features and sensor data from the SCS to the UCS based on the sensor orientation (R) and the sensor position (t) using the eq. (1). Further, in some embodiments, the controller 310 is configured to validate the calibrated one or more sensors 330 to ensure that the calibration results are accurate and reliable. In one embodiment, the validation may be performed by comparing sensor readings to known fiducial positions after the calibration. In some embodiments, the controller 310 also coordinates with the plurality of fiducial targets 308 that are strategically positioned on and around the multiaxis rotary platform 302.

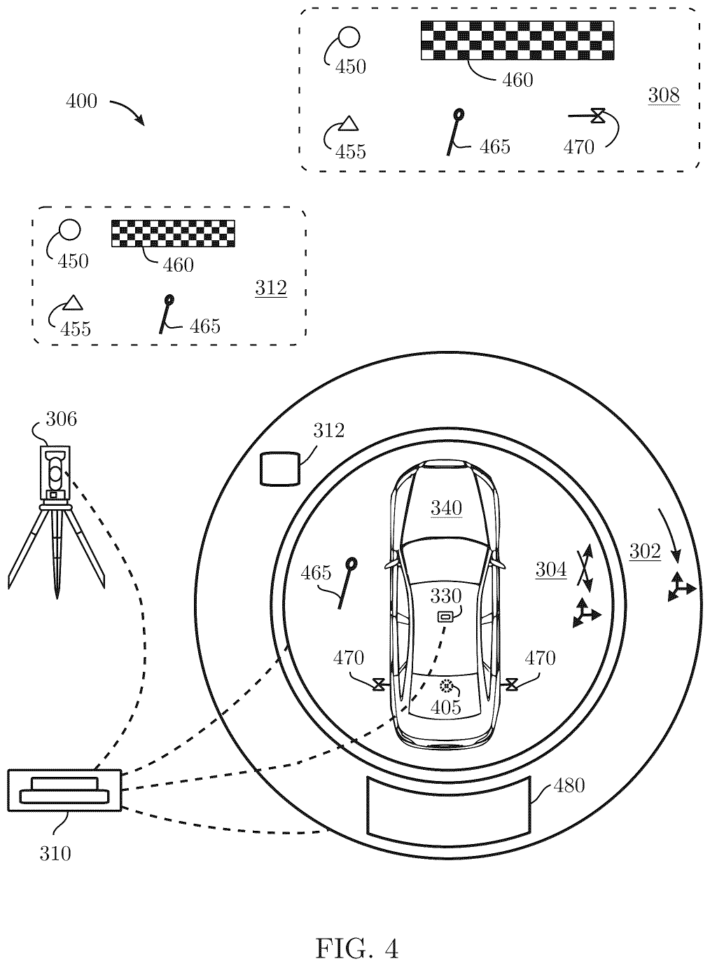

FIG. 4 shows another illustration of the vehicle system 300 in a calibration environment 400 in accordance with some embodiments of the present disclosure. As shown in FIG. 4, an assembly of platforms 360 comprises a multiaxis rotary platform 302 and a second platform 304. The vehicle 340 is equipped with the one or more sensors 330, which require calibration to ensure accurate and precise measurements and data fusion. The vehicle 340 is positioned on the second platform 304. The coordinate system associated with the vehicle 340 is referred to as the unified coordinate system (UCS) 405. The UCS 405 serves as a chosen coordinate system for calibration purposes, and calibration parameters are determined with respect to this system. A plurality of fiducial targets 308 are positioned on and around the multiaxis rotary platform 302, and they rotate with the rotary platform 302. Some fiducial targets 465, 470 are positioned on the second platform 302. In one embodiment, a set of fiducial targets 312, which is a subset of the plurality of fiducial targets 308, is positioned on the multiaxis rotary platform 302 to rotate with the rotary platform 302. In another embodiment, a pair of fiducial targets 470 is strategically positioned on the vehicle to determine the position and orientation of the center of a unified coordinate system 405 on the vehicle 340. For instance, each pair of the fiducial targets 470 can be positioned at the center of the rear wheel of the vehicle 340 if the unified coordinate system 405 is defined in the rear axle of the vehicle 340. In another embodiment, the position and orientation of the center of a unified coordinate system (UCS) 405 on the vehicle 340 is dynamically determined by matching the visual features of the vehicle 340, which is tracked by the scene tracking system 306, with a three-dimensional model of the vehicle. In another embodiment, the position and orientation of the unified coordinate system 405 is at any conveniently chosen location.

In one embodiment, the second platform 304 is a stationary platform. The vehicle 340 is positioned on the stationary platform and the multiaxis rotary platform 302 rotates around it. This is useful for large vehicles that are difficult to rotate or tilt.

In another embodiment, the second platform 304 is a multiaxis tilt platform configured to tilt in three-dimensional space, around the yaw, pitch, and roll axes of motion. The vehicle 340 is positioned on the multiaxis tilt platform, while the multiaxis rotary platform 302 rotates around it. The tilt operation of the multiaxis tilt platform is critical for the calibration of sensors, such as the IMU, which require excitation in three dimensions to achieve accurate sensitivity alignment, scale factor calibration, and drift compensation. Additionally, the tilt operation enhances the system's ability to simulate real-world motion dynamics, allowing for comprehensive testing and calibration of advanced driver-assistance systems (ADAS) and other motion-sensitive sensors.

In one embodiment, the multiaxis rotary platform 302 may be a full circular ring around the second platform 304. In another embodiment, the multiaxis rotary platform 302 may comprise an opening 480 designed to allow the vehicle 340 to ingress and egress from the second platform 304. In another embodiment, the vehicle 340 is positioned onto the second platform 304 for ingress by being lowered or dropped onto the platform and is lifted out for egress using a lift mechanism or similar system.

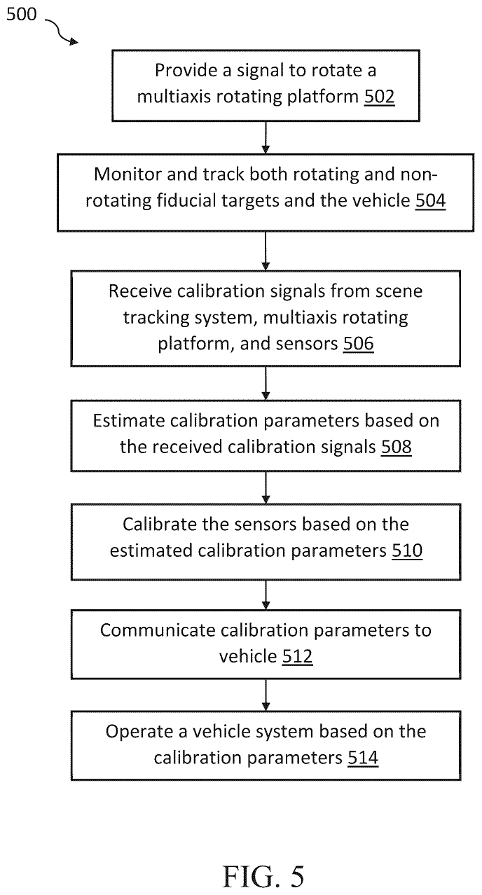

FIG. 5 is an exemplary flowchart showing a method performed by the controller in accordance with an embodiment of the present disclosure. As illustrated in FIG. 5, the method 500 comprises one or more blocks implemented by the controller 108. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method 500. Additionally, individual blocks may be deleted from the method 500 without departing from the spirit and scope of the subject matter described herein. Furthermore, the method 500 can be implemented in any suitable hardware, software, firmware, or combination thereof.

At block 502, a signal to multiaxis rotating platform is provided. In one embodiment, the signal to the multiaxis rotating platform 302 is provided by the controller 108 to rotate the multiaxis rotating platform 302 in three dimensions around the yaw, pitch, and roll axes. This signal is typically generated and transmitted by the controller 108, aiming to induce the rotation of the said platform. The signal provided to the multiaxis rotating platform 302 comprises a signal to activate a motor associated with the multiaxis rotating platform 302. Thus, the signal not only triggers the rotation but also serves as an activation command for the motor linked with the multiaxis rotating platform 302. By providing the signal to the multiaxis rotating platform 302, the calibration procedure to calibrate one or more sensors is initiated by the controller 108, which is a critical step in ensuring the accuracy and precision of one or more sensors 130 integrated into the vehicle 140.

At block 504, the scene tracking system 104 monitors and tracks the vehicle 140 along with rotating and non-rotating fiducial targets, which are part of the plurality of fiducial targets 106. The fiducial targets 106 are strategically positioned on and around the multiaxis rotating platform 102, such that some targets rotate with the platform. The scene tracking system 104 performs real-time monitoring and tracking of both the rotating and non-rotating fiducial targets, as well as the vehicle 140, to provide feedback to capture relative shifts in the positions of the fiducial targets (target positions) and positions of the sensors 130 (sensor positions) during platform rotation.

At block 506, calibration signals are received from a scene tracking system 104, multiaxis rotating platform 102, and the one or more sensors 130. In one embodiment, the calibration signals are received by the controller 108 from the scene tracking system 104, the multiaxis rotating platform 102, and the one or more sensors 130. In one embodiment, the calibration signals received from the scene tracking system 104 comprises data received by the scene tracking system 104 (Dᵢ^{TCS}) from the plurality of fiducial targets 106. In another embodiment, the calibration signals received from the one or more sensors 130 comprises data received by the one or more sensors (Dᵢ^{SCS}) from the plurality of fiducial targets 106. Further, the calibration signals received from the multiaxis rotating platform 102 comprises a vector of yaw, pitch, and roll rotation angle components (θᵢ).

At block 508, calibration parameters are estimated based on the received calibration signals. In one embodiment, the calibration parameters are estimated by the controller 108 based on the received calibration signals. In one embodiment, the estimated calibration parameters comprise a sensor orientation (R) and a sensor position (t). In one embodiment, the controller 108 utilizes the relation between three coordinate systems, as mentioned in equations 1 and 2, and re-arranges them as shown in equation 3.

In one embodiment, in order to compute the sensor orientation (R), initially the plurality of instantaneous rotations (Rᵢ) for the plurality set of detections are computed by the controller 108 based on the calibration data from the one or more sensors 130 and the scene tracking system 104. For example, each set of detections may be represented as {Dᵢ^{SCS}, Dᵢ^{TCS}} where i ranges from 0 to n time instants.

In some embodiments, each of the plurality of instantaneous rotations (Rᵢ) may be computed using the equation 4. Upon computing the instantaneous rotation (Rᵢ), each of the computed plurality of instantaneous rotations (Rᵢ) into yaw, pitch, and roll components are decomposed by the controller 108.

Further, the average yaw component, the average pitch component, and the average roll component are determined by the controller 108 based on the decomposed components and the sensor orientation (R) is estimated by the controller 108 based on the determined average yaw component, average pitch component, and average roll component.

In another embodiment, in order estimate the sensor orientation (R), initially a centroid for each of a plurality set of detections received from the one or more sensors 130 and the scene tracking system 104 is computed by the controller 108 and a plurality set of non-zero detections is determined based on the computed centroid for each of the plurality set of detections. In order to determine the non-zero detections, the centroid from each set of the plurality set of detections is removed by the controller 108. Upon determining the plurality set of non-zero detections, the sensor orientation (R) is estimated by the controller 108 based on the determined plurality set of non-zero detections using the equation (5). For example, each set of non-zero detections may be represented as {D₀ᵢ^{SCS}, D₀ᵢ^{TCS}} where i ranges from 0 to n time instants.

In one embodiment, in order to compute the sensor position (t), initially the rotation matrix Q_{(θ}_{ᵢ}₎ and the displacement vector (d) are determined by the controller 108 based on the calibration data received from the scene tracking system 104. In one embodiment, the calibration data comprises a vector of yaw, pitch, and roll rotation angle components (θᵢ) of multiaxis rotating platform 102 at the i^{th} time stamp. From the received vector of angles of rotation (θᵢ), the rotation matrix Q_{(θ}_{ᵢ}₎ is determined by the controller 108.

In order to determine the displacement vector (d), the controller 108 is configured to utilize the relationship as shown in equation (6). Further, by converting the relation in eq. (6) into matrices for n time stamps, the following observation can be made:

$$\hat{H} \approx t {1}^{T} - {J}_{( d )}$$

where Ĥ contains multiple ĥₗ data points over n timesteps and J_{(d)} encodes the effect of the multiaxis rotating platform's Q_{(θ}_{ᵢ}₎ rotation on the displacement vector d.

Using the above relation, the estimate of the displacement vector (d) is determined by the controller 108 using the equation (8). Upon determining the estimate of displacement vector (d), the sensor position (t) is computed by the controller 108 by performing an average of single sensor position estimate tₗ, where tₗ is obtained based on the determined rotation matrix Q_{(θ}_{ᵢ}₎ and the estimate of displacement vector (d) as shown in equation (9).

At block 510, the one or more sensors are calibrated based on the estimated calibration parameters. In one embodiment, the one or more sensors 130 are calibrated by the controller 108 based on the estimated calibration parameters. In one embodiment, the controller 108 performs the calibration by transforming point features from the SCS to the UCS based on the sensor orientation (R) and the sensor position (t) using the equation (1). Further, in some embodiments, validation of the calibrated one or more sensors is performed by the controller 108 to ensure that the calibration results are accurate and reliable. In one embodiment, the validation may be performed by comparing sensor readings to known fiducial positions after the calibration.

In step 512 the calibration parameters are communicated to the vehicle 140 through the network interfaces 134, 142 through the network 132. In step 514 one or more of the vehicle systems 146 are operated based on the received calibration parameters.

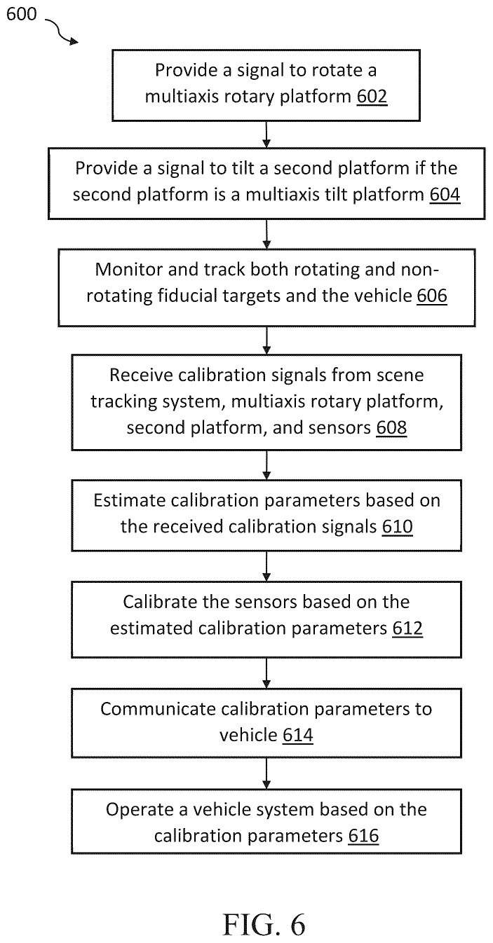

FIG. 6 is an exemplary flowchart showing a method performed by the controller in accordance with an embodiment of the present disclosure. As illustrated in FIG. 6, the method 600 comprises one or more blocks implemented by the controller 310. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method 600. Additionally, individual blocks may be deleted from the method 600 without departing from the spirit and scope of the subject matter described herein. Furthermore, the method 600 can be implemented in any suitable hardware, software, firmware, or combination thereof.

At block 602, a signal to multiaxis rotary platform is provided. In one embodiment, the signal to the multiaxis rotary platform 302 is provided by the controller 310 to rotate the multiaxis rotary platform 302 in three dimensions around the yaw, pitch, and roll axes. This signal is typically generated and transmitted by the controller 310, aiming to induce the rotation of the said platform. The signal provided to the multiaxis rotary platform 302 comprises a signal to activate a motor associated with the multiaxis rotary platform 302. Thus, the signal not only triggers the rotation but also serves as an activation command for the motor linked with the multiaxis rotary platform 302. By providing the signal to the multiaxis rotary platform 302, the calibration procedure to calibrate one or more sensors is initiated by the controller 310, which is a critical step in ensuring the accuracy and precision of one or more sensors 330 integrated into the vehicle 340.

At block 604, a signal to tilt second platform is provided. In one embodiment, the second platform 304 is a multiaxis tilt platform, and the signal to the second platform 304 is provided by the controller 310 to tilt the second platform 304 in three dimensions around the yaw, pitch, and roll axes. This signal is typically generated and transmitted by the controller 310, aiming to induce the tilt of the said platform. The signal provided to the second platform 304 comprises a signal to activate a motor associated with the second platform 304. Thus, the signal not only triggers the tilt but also serves as an activation command for the motor linked with the second platform 304. By providing the signal to the second platform 304, the calibration procedure to calibrate one or more sensors is initiated by the controller 310, which is a critical step in ensuring the accuracy and precision of one or more sensors 330 integrated into the vehicle 340.

At block 606, the scene tracking system 306 monitors and tracks the vehicle 340 along with rotating and non-rotating fiducial targets, which are part of the plurality of fiducial targets 308. These fiducial targets are strategically positioned on and around the multiaxis rotary platform 302, such that some targets rotate with the platform. The scene tracking system 306 performs real-time monitoring and tracking of both the rotating and non-rotating fiducial targets, as well as the vehicle 340, to capture relative shifts in the positions of the fiducial targets and sensors 330 during platform rotation.

At block 608, calibration signals are received from a scene tracking system 306, multiaxis rotary platform 302, second platform 304, and the one or more sensors 330. In one embodiment, the calibration signals are received by the controller 310 from the scene tracking system 306, the multiaxis rotary platform 302, the second platform 304, and the one or more sensors 330. In one embodiment, the calibration signals received from the scene tracking system 306 comprises data received by the scene tracking system 306 (Dᵢ^{TCS}) from the plurality of fiducial targets 308. In another embodiment, the calibration signals received from the one or more sensors 330 comprises data received by the one or more sensors (Dᵢ^{SCS}) from the plurality of fiducial targets 308. Further, the calibration signals received from the multiaxis rotary platform 302 comprises a vector of yaw, pitch, and roll rotation angle components (θᵢ). Further, the calibration signals received from the second platform 304 comprises another vector of yaw, pitch, and roll rotation angle components, representing the tilt operation of the second platform.

At block 610, calibration parameters are estimated based on the received calibration signals. In one embodiment, the calibration parameters are estimated by the controller 310 based on the received calibration signals. In one embodiment, the estimated calibration parameters comprise a sensor orientation (R) and a sensor position (t). In one embodiment, the controller 310 utilizes the relation between three coordinate systems, as mentioned in equations 10 and 11, and re-arranges them as shown in equation 12.

In one embodiment, in order to compute the sensor orientation (R), initially the plurality of instantaneous rotations (\hat{R}ᵢ) for the plurality set of detections are computed by the controller 310 based on the calibration data from the one or more sensors 330 and the scene tracking system 306. For example, each set of detections may be represented as {Dᵢ^{SCS}, Dᵢ^{TCS}} where i ranges from 0 to n time instants.

In some embodiments, each of the plurality of instantaneous rotations (\hat{R}ᵢ) may be computed using the equation 13. Upon computing the instantaneous rotation (\hat{R}ᵢ), each of the computed plurality of instantaneous rotations (\hat{R}ᵢ) into yaw, pitch, and roll components re decomposed by the controller 310.

Further, the average yaw component, the average pitch component, and the average roll component are determined by the controller 310 based on the decomposed components and the sensor orientation (R) is estimated by the controller 310 based on the determined average yaw component, average pitch component, and average roll component.

In another embodiment, in order estimate the sensor orientation (R), initially a centroid for each of a plurality set of detections received from the one or more sensors 330 and the scene tracking system 306 is computed by the controller 310 and a plurality set of non-zero detections is determined based on the computed centroid for each of the plurality set of detections. In order to determine the non-zero detections, the centroid from each set of the plurality set of detections is removed by the controller 310. Upon determining the plurality set of non-zero detections, the sensor orientation (R) is estimated by the controller 310 based on the determined plurality set of non-zero detections using the equation (14). For example, each set of non-zero detections may be represented as {D₀ᵢ^{SCS}, D₀ᵢ^{TCS}} where i ranges from 0 to n time instants.

In one embodiment, in order to compute the sensor position (t), initially the rotation matrix Q_{(θ}_{ᵢ}₎^{T} and the displacement vector (d) are determined by the controller 310 based on the calibration data received from the scene tracking system 306. In one embodiment, the calibration data comprises a vector of yaw, pitch, and roll rotation angle components (θᵢ) of multiaxis rotary platform 302 at the i^{th} time stamp. From the received vector of angles of rotation (θᵢ), the rotation matrix Q_{(θ}_{ᵢ}₎^{T} is determined by the controller 310.

In order to determine the displacement vector (d), the controller 310 is configured to utilize the relationship as shown in equation (15). Further, by converting the relation in eq. (15) into matrices for n time stamps, the following observation can be made:

$$\hat{H} \approx t {1}^{T} - {J}_{( d )}$$

where Ĥ contains multiple ĥₗ data points over n timesteps and J_{(d)} encodes the effect of the multiaxis rotary platform's Q_{(θ}_{ᵢ}₎^{T} rotation on the displacement vector d.

Using the above relation, the estimate of the displacement vector (\hat{d}) is determined by the controller 310 using the equation (17). Upon determining the estimate of displacement vector (\hat{d}), the sensor position (t) is computed by the controller 310 by performing an average of single sensor position estimate \hat{t}ₗ, where \hat{t}ₜ is obtained based on the determined rotation matrix Q_{(θ}_{ᵢ}₎^{T} and the estimate of displacement vector (\hat{d}) as shown in equation (18).

At block 612, the one or more sensors are calibrated based on the estimated calibration parameters. In one embodiment, the one or more sensors 330 are calibrated by the controller 310 based on the estimated calibration parameters. In one embodiment, the calibration is performed by the controller 310 by transforming point features from the SCS to the UCS based on the sensor orientation (R) and the sensor position (t) using the equation (10). Further, in some embodiments, validation of the calibrated one or more sensors is performed by the controller 310 to ensure that the calibration results are accurate and reliable. In one embodiment, the validation may be performed by comparing sensor readings to known fiducial positions after the calibration.

In step 614, the calibration parameters are communicated to the vehicle 340 through the network interfaces 334, 342 through the network 332. In step 616 one or more of the vehicle systems 346 are operated based on the received calibration parameters.

The methods described herein may be performed using the systems described herein. In addition, it is contemplated that the methods described herein may be performed using systems different than the systems described herein. Moreover, the systems described herein may perform the methods described herein and may perform or execute the instructions stored in the computer-readable storage media (CRSMs) described herein. It is also contemplated that the systems described herein may perform functions or execute instructions other than those described in relation to the methods and CRSMs described herein.

Furthermore, the CRSMs described herein may store instructions corresponding to the methods described herein and may store instructions that may be performed or executed by the systems described herein. Furthermore, it is contemplated that the CRSMs described herein may store instructions different than those corresponding to the methods described herein and may store instructions which may be performed by systems other than the systems described herein.

The methods, systems, and CRSMs described herein may include the features or perform the functions described herein in association with any one or more of the other methods, systems, and CRSMs described herein.

The above description of shown example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In some embodiments, the method or methods described above may be executed or carried out by a computing system (for example, the controller 108 or the controller 310) including a tangible computer-readable storage medium, also described herein as a storage machine, that holds machine-readable instructions executable by a logic machine (e.g., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an API.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A sensor calibration system for a sensor-equipped unit, comprising:
a multiaxis rotating platform configured to rotate in one or more axes, comprising a yaw axis of motion, a pitch axis of motion, and roll axis of motion, wherein the multiaxis rotating platform is sized to receive the sensor-equipped unit comprising sensors to be calibrated;
a motor operatively associated with the multiaxis rotating platform, wherein the motor controls the rotation of the platform in one or more axes, comprising a yaw axis of motion, a pitch axis of motion, and roll axis of motion;
a plurality of fiducial targets positioned both on and around the rotating platform, wherein the fiducial targets positioned on the platform rotate with the platform;
a scene tracking system configured to monitor and track both rotating and non-rotating fiducial targets, and the sensor-equipped unit, wherein the scene tracking system provides feedback by capturing relative shifts in target positions and sensor positions as the platform rotates; and
a controller, coupled to at least one of the one or more sensors, the multiaxis rotating platform, and the scene tracking system, and configured to:
receive calibration data from the one or more sensors, the multiaxis rotating platform, and the scene tracking system;
determine at least one calibration parameter from the calibration data; and
calibrate the one or more sensors based on the at least one calibration parameter.

2. The system of claim 1, wherein the calibration data received by the controller includes non-fiducial target features within a calibration environment detected by the one or more sensors, the non-fiducial target features comprising at least one of edges, textures, or patterns of objects within the calibration environment, wherein the controller uses the non-fiducial target features in combination with fiducial target data to determine the at least one calibration parameter.

3. The system of claim 1, wherein the calibration data received by the controller includes non-fiducial target features within a calibration environment monitored and tracked by the scene tracking system, the non-fiducial target features comprising at least one of edges, textures, or patterns of objects within the calibration environment, wherein the controller uses the non-fiducial target features in combination with fiducial target data to determine the at least one calibration parameter.

4. The system of claim 1, wherein the controller is further configured to dynamically adapt a calibration process based on a specific configuration of the one or more sensors on the sensor-equipped unit, including variations in sensor types, positions, orientations, fields of view, and using sensor fusion techniques, such as Kalman filtering, Bayesian fusion, or neural network-based signal processing, for integrating and enhancing accuracy of the at least one calibration parameter.

5. The system of claim 1, wherein the controller communicates the at least one calibration parameter to the sensor-equipped unit through a network to a memory device operatively connected to the sensor-equipped unit wherein the sensor-equipped unit operates a system of the sensor-equipped unit based on the at least one calibration parameter.

6. The system of claim 1, wherein the controller is operatively coupled to the one or more sensors, the multiaxis rotating platform, and the scene tracking system via a wired or wireless network, the controller configured to receive calibration data and perform a calibration regardless of physical location relative to the sensor-equipped unit.

7. The system of claim 1, wherein the calibration performed by the controller is configured to operate in real time as the calibration data is received from the one or more sensors, the multiaxis rotating platform, and the scene tracking system, or alternatively, the calibration data is stored in a memory device for subsequent processing to compute the at least one calibration parameter.

8. A sensor calibration system for a sensor-equipped unit comprising:
an assembly of platforms which comprises a multiaxis rotary platform and a second platform, wherein the multiaxis rotary platform is configured to rotate around the second platform, wherein the rotation occurs in one or more axes, comprising a yaw axis of motion, a pitch axis of motion, and roll axis of motion;
wherein a sensor-equipped unit comprising sensors to be calibrated is placed on the second platform;
a motor operatively associated with the multiaxis rotary platform, wherein the motor is capable of controlling the rotation of the rotary platform in one or more axes, comprising a yaw axis of motion, a pitch axis of motion, and roll axis of motion;
a plurality of fiducial targets positioned both on and around the rotary platform, wherein the fiducial targets positioned on the rotary platform rotate with the rotary platform;
a scene tracking system configured to monitor and track both rotating and non-rotating fiducial targets, and the sensor-equipped unit, wherein the scene tracking system provides feedback by capturing relative shifts in target positions and sensor positions as the rotary platform rotates; and
a controller, coupled to at least one of the one or more sensors, the assembly of platforms, and the scene tracking system, and configured to:
receive calibration data from the one or more sensors, the assembly of platforms, and the scene tracking system;
determine at least one calibration parameter from the calibration data; and
calibrate the one or more sensors based on the at least one calibration parameter.

9. The system of claim 8, wherein the second platform is a stationary, non-rotating platform.

10. The system of claim 8, wherein the second platform is a multiaxis tilt platform configured to tilt in one or more axes, comprising a yaw axis of motion, a pitch axis of motion, and roll axis of motion, and further comprising a motor operatively associated with the multiaxis tilt platform, wherein the motor controls the tilt of the platform in one or more axes, comprising a yaw axis of motion, a pitch axis of motion, and roll axis of motion.

11. The system of claim 8, wherein the multiaxis rotary platform comprises an opening that is configured to enable the sensor-equipped unit to ingress onto or egress from the second platform.

12. The system of claim 8, wherein the calibration data received by the controller includes non-fiducial target features within a calibration environment detected by the one or more sensors, the non-fiducial target features comprising at least one of edges, textures, or patterns of objects within the calibration environment, wherein the controller uses the non-fiducial target features in combination with fiducial target data to determine the at least one calibration parameter.

13. The system of claim 8, wherein the calibration data received by the controller includes non-fiducial target features within a calibration environment monitored and tracked by the scene tracking system, the non-fiducial target features comprising at least one of edges, textures, or patterns of objects within the calibration environment, wherein the controller uses the non-fiducial target features in combination with fiducial target data to determine the at least one calibration parameter.

14. The system of claim 8, wherein the controller is further configured to dynamically adapt a calibration process based on a specific configuration of the one or more sensors on the sensor-equipped unit, including variations in sensor types, positions, orientations, fields of view, and using sensor fusion techniques, such as Kalman filtering, Bayesian fusion, or neural network-based signal processing, for integrating and enhancing accuracy of the at least one calibration parameter.

15. The system of claim 8, wherein the controller communicates the at least one calibration parameter to the sensor-equipped unit through a network to a memory device operatively connected to the sensor-equipped unit wherein the sensor-equipped unit operates a system of the sensor-equipped unit based on the at least one calibration parameter.

16. The system of claim 8, wherein the controller is operatively coupled to the one or more sensors, the assembly of platforms, and the scene tracking system via a wired or wireless network, enabling the controller to receive calibration data and perform calibration regardless of a physical location relative to the sensor-equipped unit.

17. The system of claim 8, wherein the calibration performed by the controller is configured to operate in real time as the calibration data is received from the one or more sensors, the assembly of platforms, and the scene tracking system, or alternatively, the calibration data is stored in a memory device for subsequent processing to compute the at least one calibration parameter.

18. A method of calibrating a sensor-equipped unit comprising:
providing a signal to rotate a platform,
rotating the platform in one or more axes,
comprising a yaw axis of motion, a pitch axis of motion, and a roll axis of motion;
monitoring and tracking both rotating and non-rotating fiducial targets and a sensor-equipped unit;
receiving calibration data from a scene tracking system, the platform, and one or more sensors of the sensor-equipped unit;
determining calibration parameters based on the calibration data; and
calibrating the one or more sensors based on the calibration parameters.

19. The method of claim 18, further comprising communicating a signal to tilt a second platform when the second platform is a multiaxis tilt platform and tilting the second platform in one or more axes, comprising the yaw axis, the pitch axis, and the roll axis.

20. The method of claim 18, further comprising transmitting calibration parameters to the sensor-equipped unit over a network; and operating the sensor-equipped unit based on the calibration parameters.

21. A non-transitory computer-readable storage medium having stored thereon instructions that, when executed by a processor, cause the processor to:
provide a signal to rotate a platform, wherein the platform is configured to rotate in one or more axes, comprising a yaw axis of motion, a pitch axis of motion, and a roll axis of motion;
monitor and track both rotating and non-rotating fiducial targets and a sensor-equipped unit;
receive calibration data from a scene tracking system, the platform, and one or more sensors of the sensor-equipped unit;
determine calibration parameters based on the received calibration data, and
calibrate the one or more sensors based on the calibration parameters.

22. The system of claim 21, wherein the processor is further configured to provide a signal to tilt a second platform when the second platform is a multiaxis tilt platform that is configured to tilt in one or more axes, comprising the yaw axis, the pitch axis, and the roll axis.

23. The system of claim 21, wherein the processor is further configured to transmit calibration parameters to the sensor-equipped unit over a network for use during operation of the sensor-equipped unit.
